(19) United States
(12) Patent Application Publication
(10) Pub. No.: US 2011/0292441 A1
(43) Pub. Date: Dec. 1, 2011

(54) IMAGE READING APPARATUS AND SETTING AUTOMATION METHOD

(75) Inventors: Masahiko KOBAKO, Ishikawa (JP); Jun Matoba, Ishikawa (JP)

(73) Assignee: PFU LIMITED

(21) Appl. No.: 13/077,218

(22) Filed: Mar. 31, 2011

(30) Foreign Application Priority Data
Jun. 1, 2010 (JP) 2010-126118

(51) Int. Cl. H04N 1/04; G06F 3/12

(52) U.S. Cl. 358/1.15; 358/498

(57) ABSTRACT

An image reading apparatus includes a paper type sensor that detects a paper type of paper, a control unit, and a reading unit that performs an image reading. The control unit includes a mode setting unit that sets a mode of the image reading performed by the reading unit based on the paper type detected by the paper type sensor.

### CROSS-REFERENCE TO RELATED APPLICATION

This application is based upon and claims the benefit of priority from Japanese Patent Application No. 2010-126118, filed on Jun. 1, 2010, the entire contents of which are incorporated herein by reference.

### BACKGROUND OF THE INVENTION

1. Field of the Invention

The present invention relates to an image reading apparatus such as a scanner, a copier, and a facsimile, a setting automation method executed by the image reading apparatus, and a setting automation program that the image reading apparatus is caused to execute.

2. Description of the Related Art

As a conventional technology, website (URL:“http://www.nikkeibp.co.jp/archives/113/113953.html”) of Nikkei BP discloses a product for printing by using a reflection coefficient of light to determine paper quality and performing color matching suitable for the paper quality. As for a scanner, automatic determination of resolution is executed by using a size of paper and automatic determination of a mono-color discrimination is also executed by using a colored area of a document.

Other conventional technologies include those disclosed in website

(URL:“http://wwwca.kodak.com/JP/ja/business/special/benefit/koritsu.shtml”) of Kodak Co. Ltd., JP-A-10-55417, JP-A-10-275209, JP-A-2002-366942, U.S. Patent Application No. 2002/0156754, U.S. Patent Application No. 2002/0196479, and U.S. Patent Application No. 2001/0042085.

JP-A-10-55417 discloses a technology for a batch processing system of a plurality of formats performed by an OCR (Optical Character Reader) using an ADF (Automatic Document Feeder). JP-A-10-275209 discloses a technology for an image data processing system and an image data processing method for automatically starting an application program related to an individual image data process according to a type of discretely read image data in an information processing apparatus connected with an image scanner apparatus. JP-A-2002-366942 discloses a technology for an image reading system for automatically determining whether a document to be read is a reflective manuscript or a transparent manuscript and executing an appropriate process according to its type, and for a control program of the image reading system.

U.S. Patent Application No. 2002/0156754 discloses a technology for a method and a system for selecting a print mode of a printer using a neural network. U.S. Patent Application No. 2002/0196479 discloses a technology for a method and system for performing a process set in each format on a scanned image, based on information for a text, monochrome/color, an image, and the like. U.S. Patent Application No. 2001/0042085 discloses a technology for a method or the like for sorting scanned data using a character attribute and an image attribute and allocating the sorted data to a set folder.

However, there is a problem that complicated setting like setting of a read mode is required at the time of using an image reading apparatus such as a scanner, and this leaves some aspects to be improved in terms of its usability.

### SUMMARY OF THE INVENTION

It is an object of the present invention to at least partially solve the problems in the conventional technology.

An image reading apparatus according to one aspect of the present invention includes a paper type sensor that detects a paper type of paper, a control unit, and a reading unit that performs an image reading. The control unit includes a mode setting unit that sets a mode of the image reading performed by the reading unit based on the paper type detected by the paper type sensor.

A setting automation method according to one aspect of the present invention is executed by a control unit of an image reading apparatus that includes a paper type sensor for detecting a paper type of paper, the control unit, and a reading unit for performing an image reading. The setting automation method includes a mode setting step of setting a mode of the image reading performed by the reading unit based on the paper type detected by the paper type sensor.

A computer-readable recording medium according to one aspect of the present invention stores therein a computer program causing an image reading apparatus to execute a setting automation method. The image reading apparatus includes a paper type sensor for detecting a paper type of paper, a control unit, and a reading unit for performing an image reading. The setting automation method executed by the control unit includes a mode setting step of setting a mode of the image reading performed by the reading unit based on the paper type detected by the paper type sensor.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of one examples of configurations of an image reading apparatus and an information processing apparatus;

FIG. 2 is a schematic representing one example of a configuration of the image reading apparatus;

FIG. 3 is a schematic representing one examples of properties of paper sheets desired to be sorted and applications desired to be started;

FIG. 4 is a flowchart representing one example of a main process executed by the image reading apparatus;

FIG. 5 is a flowchart representing one example of a main process executed by the information processing apparatus;

FIG. 6 is a diagram representing one example of a viewer display of images using a type and a size of paper as parameters; and

FIG. 7 is a diagram representing another example of the viewer display of images using a type and a size of paper as parameters.

### DETAILED DESCRIPTION OF THE PREFERRED EMBODIMENTS

Embodiments of an image reading apparatus, a setting automation method, and a setting automation program according to the present invention will be explained in detail below with reference to the accompanying drawings. It should be noted that the present invention is not limited by the embodiments.

1. Configuration of Present Embodiment

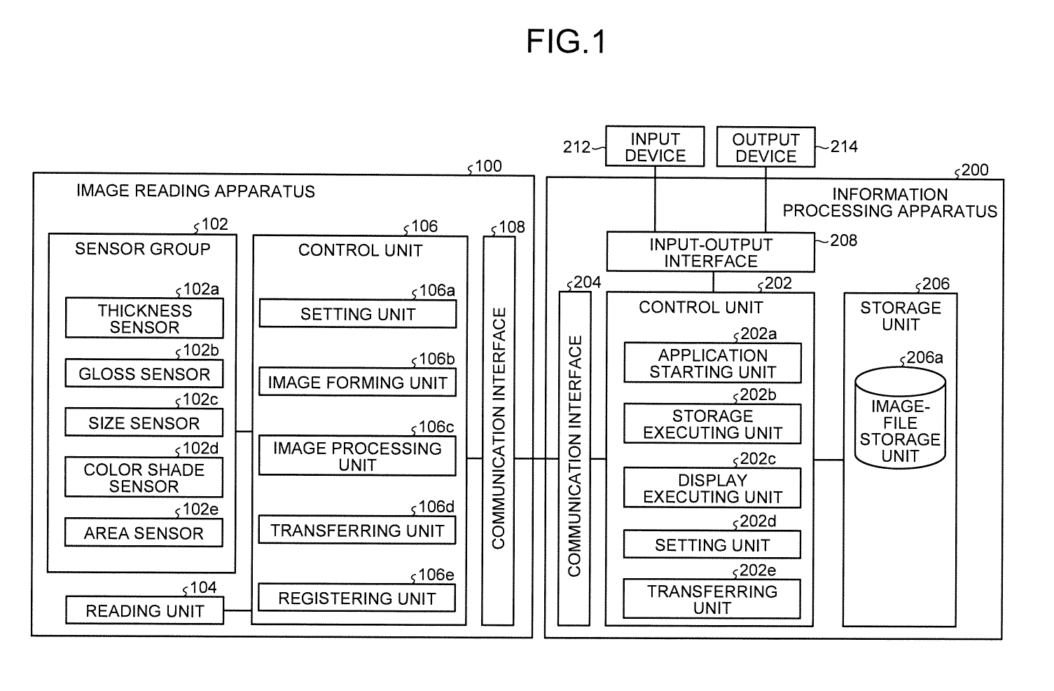

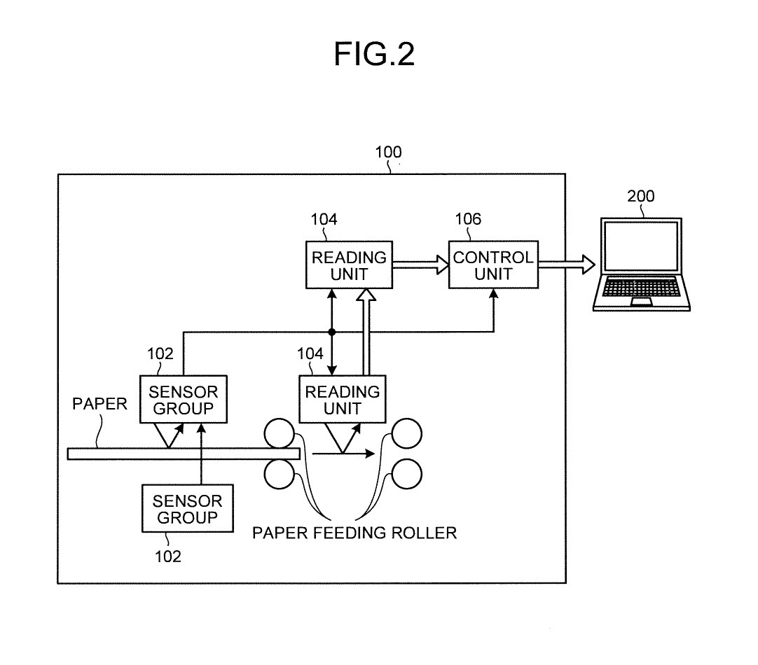

Configurations of an image reading apparatus and an information processing apparatus according to a present embodiment will be explained with reference to FIG. 1 and FIG. 2. FIG. 1 is a block diagram of one examples of the configurations of the image reading apparatus and the information processing apparatus. FIG. 2 is a schematic representing one example of the configuration of the image reading apparatus.

An image reading apparatus 100 is, specifically, a scanner, a copier, a facsimile, or the like. The image reading apparatus 100 includes a sensor group 102 including a paper type sensor according to the present invention, a reading unit 104, a control unit 106, and a communication interface 108. The image reading apparatus 100 is communicably connected with an information processing apparatus 200.

The sensor group 102 is a mechanism for detecting a paper type of paper (specifically, paper quality, gloss, thickness, degree of whiteness, color, reflectance, and transmittance, etc.) and a size of paper (specifically, length, width, A4, and B5, etc.), and includes a thickness sensor 102a, a gloss sensor 102b, a size sensor 102c, a color shade sensor 102d, and an area sensor 102e for detecting a whole size.

The reading unit 104 is a mechanism for performing an image reading of paper according to a read mode (specifically, reading speed (feeding speed), resolution, brightness/contrast, color/monochrome, or the like) set by a setting unit 106a explained later, or according to a default read mode.

Here, one example of a positional relationship between the sensor group 102 and the reading unit 104 is shown in FIG. 2. To sense a type and a size of paper before the image reading of the paper is performed, the sensor group 102 is disposed in a position near a feed path of the paper and on the upstream of a position of the reading unit 104 as shown in this figure.

Referring back to FIG. 1, the communication interface 108 communicably connects the image reading apparatus 100 to the information processing apparatus 200. The communication interface 108 has a function of communicating data with the information processing apparatus 200 via a communication line.

The control unit 106 is configured with a CPU (Central Processing Unit) or the like for integrally controlling the image reading apparatus 100. The control unit 106 includes an internal memory for storing therein a control program and programs defining various processing procedures or the like and also storing therein required data, and performs information processing for executing various processes based on the programs.

The control unit 106 includes the setting unit 106a including a mode setting unit, an application setting unit, and a file setting unit according to the present invention; an image forming unit 106b; an image processing unit 106c including a recording unit according to the present invention; a transferring unit 106d; and a registering unit 106e.

The setting unit 106a sets a read mode, a start application (an application to be started by the information processing apparatus 200), and a storage folder (a folder (e.g., “my picture” folder) in the information processing apparatus 200 to store an image file created by the image processing unit 106c explained later) suitable for a type and a size of paper based on the type and the size of the paper detected by the sensor group 102.

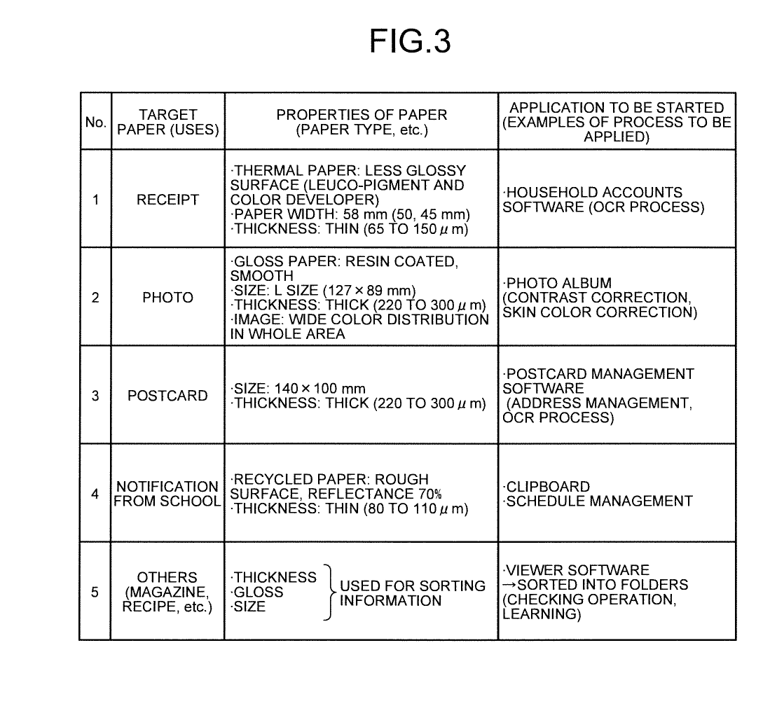

Specifically, the setting unit 106a determines a use of paper (specifically, receipt, photo, postcard, notification from school, etc.) according to predetermined criteria based on the type and size of the paper, and sets a read mode, a start application, and a storage folder suitable for the use, based on the determined use. The use of paper may be estimated from color, reflectance, and transmittance, or the like, as disclosed in Japanese Patent No. 3413889. One example of the predetermined criteria will be explained in detail in “2. Processes of Present Embodiment”. In addition, the setting unit 106a sets a start application and a storage folder by referring to a preset correspondence table for a correspondence relation among the use, the type and size of paper, the start application, and the storage folder, based on the information for the type and size of paper or the information for the use. Specifically, the setting unit 106a may set a start application by referring to a correspondence table shown in FIG. 3.

Referring back to FIG. 1, the image forming unit 106b forms an image showing the paper from an electrical signal generated based on the result of reading the paper by the reading unit 104. The image processing unit 106c performs image processing in such a manner that an image file (e.g., JPEG (Joint Photographic Experts Group) file) including the image formed by the image forming unit 106b is created and information for the type and size of the paper detected by the sensor group 102 is recorded in the created image file. Specifically, the image processing unit 106c records the information for the type and size of the paper in a header portion of the JPEG file.

The transferring unit 106d transfers the information for the start application and the storage folder set by the setting unit 106a and the image file created by the image processing unit 106c to the information processing apparatus 200. The registering unit 106e registers the information for the use, the start application, and the storage folder transferred from the information processing apparatus 200, in the preset correspondence table in association with the information for the type and size of the paper.

The information processing apparatus 200 is a personal computer communicably connected to the image reading apparatus 100. The information processing apparatus 200 includes a control unit 202, a communication interface 204, a storage unit 206, and an input-output interface 208, which are communicably connected to each other through an arbitrary communication path.

The communication interface 204 communicably connects the information processing apparatus 200 to the image reading apparatus 100 and other terminals. The communication interface 204 has a function for communicating data with the image reading apparatus 100 and the other terminals via a communication line.

The storage unit 206 is a storage unit which includes an image-file storage unit 206a for storing therein the image file transferred from the image reading apparatus 100.

The input-output interface 208 connects an input device 212 and an output device 214 to the information processing apparatus 200. Here, as the output device 214, there can be used a speaker and a printer in addition to a monitor (including a home-use television). Hereinafter, the output device 214 is sometimes described as monitor 214. As the input device 212, in addition to a keyboard, a mouse, and a microphone, there can be used a monitor for achieving a pointing device function in cooperation with the mouse.

The control unit 202 is configured with a CPU or the like for integrally controlling the information processing apparatus 200. The control unit 202 includes an internal memory for storing therein a control program such as OS (Operating System) and programs defining various processing procedures or the like and also storing therein required data, and performs information processing for executing various processes based on the programs. The control unit 202 includes an application starting unit 202a, a storage executing unit 202b, a display executing unit 202c, a setting unit 202d, and a transferring unit 202e.

The application starting unit 202a starts an application specified by the information for the start application transferred from the image reading apparatus 100. The storage executing unit 202b stores the image file transferred from the image reading apparatus 100 in a folder specified by the information for the storage folder transferred from the image reading apparatus 100. The display executing unit 202c displays (maps) the image included in the image file on the monitor 214 using the information for the type and size of the paper included in the image file as parameters.

The setting unit 202d sets a use of the paper, a start application, and a storage folder for the parameters (type and size of the paper). The transferring unit 202e transfers the information for the use, the start application, and the storage folder set by the setting unit 202d to the image reading apparatus 100.

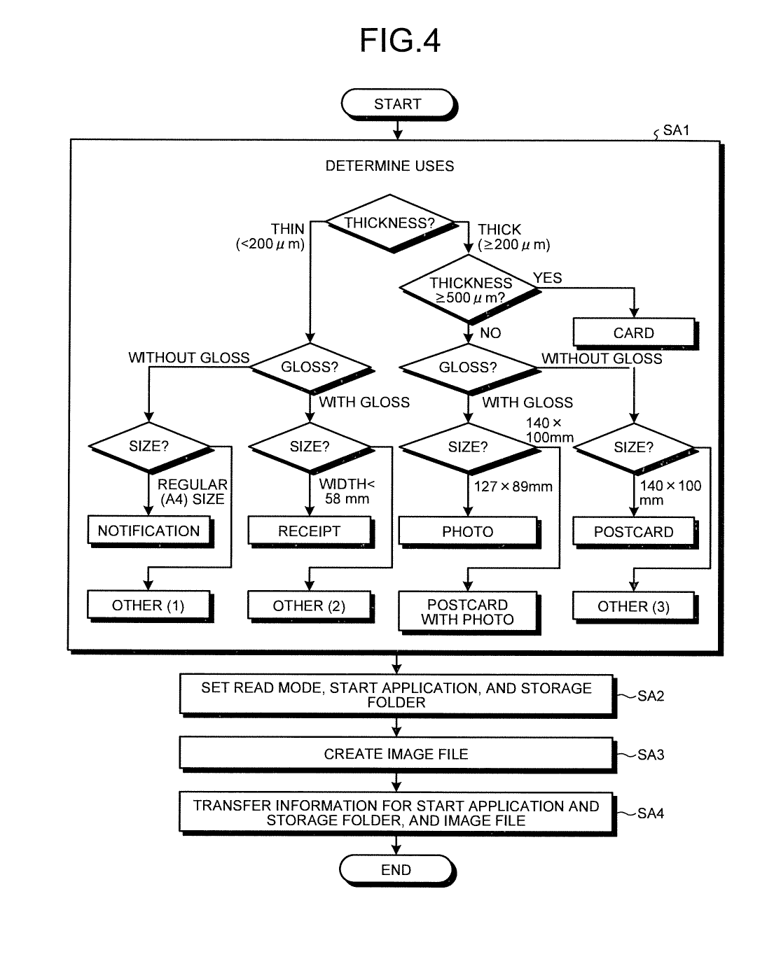

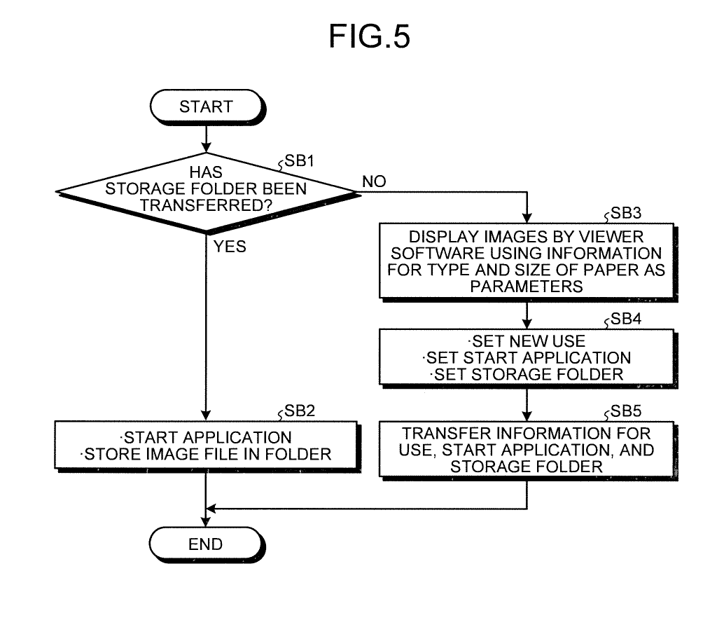

2. Processes of Present Embodiment One examples of main processes respectively executed by the image reading apparatus 100 and the information processing apparatus 200 configured in the above manner will be explained with reference to FIG. 4, FIG. 5, and the related figures.

2-1. Main Process Executed by Image Reading Apparatus 100

Here, one example of the main process executed by the image reading apparatus 100 will be explained with reference to FIG. 4.

First, the setting unit 106a determines the use of paper according to the following criteria based on the thickness, the paper with or without gloss, and the size detected by the sensor group 102 (Step SA1).

Criteria:
1. If the paper is less than 200 μm in thickness, is not glossy, and is regular size (A4), its use is determined as “notification”.
2. If the paper is less than 200 μm in thickness, is not glossy, and is not regular size (A4), its use cannot be specified (which does not correspond to any one of previously estimated uses (“receipt”, “photo”, “postcard with photo”, “postcard”, “notification”, and “card”)), and thus the use is determined as “other (1)”.
3. If the paper is less than 200 μm in thickness, is glossy, and is less than 58 mm in width, its use is determined as “receipt”.
4. If the paper is less than 200 μm in thickness, is glossy, and is not less than 58 mm in width, its use cannot be specified, and thus the use is determined as “other (2)”.
5. If the paper is 200 μm or more and less than 500 μm in thickness, is glossy, and is 127×89 mm in size, its use is determined as “photo”.
6. If the paper is 200 μm or more and less than 500 μm in thickness, is glossy, and is 140×100 mm in size, its use is determined as “postcard with photo”.
7. If the paper is 200 μm or more and less than 500 μm in thickness, is not glossy, and is 140×100 mm in size, its use is determined as “postcard”.
8. If the paper is 200 μm or more and less than 500 μm in thickness, is not glossy, and is not 140×100 mm in size, its use cannot be specified, and thus the use is determined as “other (3)”.
9. If the paper is 500 μm or more in thickness, its use is determined as “card”.

Next, the setting unit 106a sets at least one of the read mode, the start application, and the storage folder suitable for the use based on the use determined at Step SA1 (Step SA2).

Specifically, when the use is determined as “photo”, then the setting unit 106a sets contrast (γ setting) as the read mode so that the gradation is finely reproduced. Moreover, in order not to damage the surface of the photo, the setting unit 106a sets a feeding speed to be slower as the read mode. The setting unit 106a sets a photo album as the start application. When a photo of a person is assumed, in order to automatically correct the skin color and red eye of the person and then attach the photo to the photo album, the setting unit 106a further sets retouch software to perform the correction, as the start application. In addition, the setting unit 106a sets a “my picture” folder as the storage folder.

When the use is determined as “receipt”, then the setting unit 106a sets a monochrome binary mode as the read mode in which a resolution is 300 dpi or more. The setting unit 106a also sets OCR (Optical Character Recognition) software and household accounts software as the start application. The setting unit 106a also sets a “receipt” folder as the storage folder.

When the use is determined as “postcard” or “postcard with photo”, then the setting unit 106a sets a gray mode (“postcard”) with a resolution of 300 dpi or sets a color mode (“postcard with photo”) with a resolution of 300 dpi as the read mode. The setting unit 106a sets postcard management software as the start application. The setting unit 106a also sets a “postcard” folder as the storage folder.

When the use is determined as “notification”, then the setting unit 106a sets a monochrome binary mode with a resolution of 200 dpi as the read mode. In addition, the setting unit 106a sets clipboard or schedule management as the start application. The setting unit 106a also sets a “notification” folder as the storage folder.

When the use is determined as “card”, then the setting unit 106a sets a color mode with a resolution of 200 dpi, in which the feeding speed is set slower, as the read mode. In addition, the setting unit 106a sets the household accounts software as the start application. The setting unit 106a sets a “receipt” folder as the storage folder.

When the use is determined as “other (1)”, “other (2)”, or “other (3)” (when the use cannot be specified), then the setting unit 106a sets the viewer software as the start application so that any operation such as sorting of image files can be performed by the information processing apparatus 200.

Next, the image forming unit 106b forms an image showing the paper from the electrical signal generated based on the result of reading the paper by the reading unit 104 according to the read mode (default read mode when the use cannot be specified at Step SA1) set at Step SA2. The image processing unit 106c creates an image file in which the formed image is included and the information for the type and size of the paper detected at Step SA1 is also recorded (Step SA3).

Next, the transferring unit 106d transfers the information for the start application and/or the storage folder set at Step SA2 and the image file created at Step SA3 to the information processing apparatus 200 (Step SA4).

The registering unit 106e registers the information for the use, the storage folder, and the start application transferred at Step SB5 of a main process, which is explained later, performed by the information processing apparatus 200 in a preset correspondence table in association with the type and size of the paper. The explanation on the main process performed by the image reading apparatus 100 is ended herein.

2-2. Main Process Performed by Information Processing Apparatus 200

Here, one example of the main process performed by the information processing apparatus 200 subsequently to the main process performed by the image reading apparatus 100 will be explained with reference to FIG. 5 and the related figures.

First, when the information for the start application and the storage folder and the image file have been transferred from the image reading apparatus 100 (Yes at Step SB1), this case indicates that the use of the paper is specified. Therefore, the application starting unit 202a starts the application specified by the transferred information for the start application for the transferred image file, and the storage executing unit 202b stores the transferred image file in the folder specified by the transferred information for the storage folder (Step SB2).

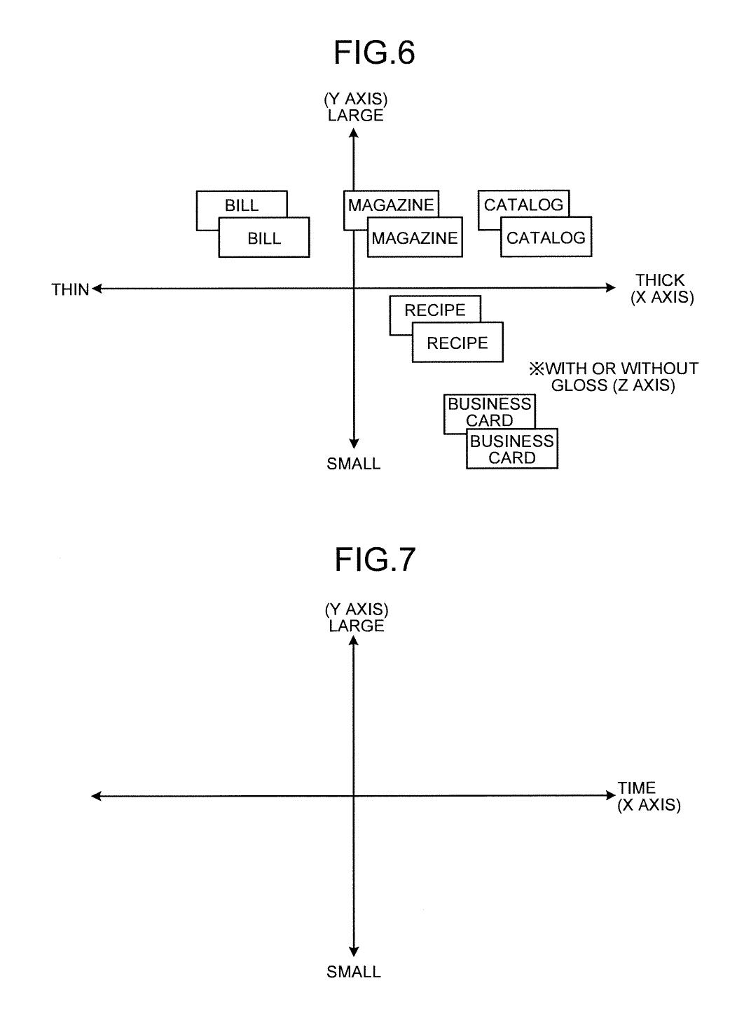

Meanwhile, when the information for the start application and the image file have been transferred from the image reading apparatus 100 (or when the information for the storage folder has not been transferred) (No at Step SB1), this case indicates that the use of the paper is not specified. Therefore, the storage executing unit 202b stores the transferred image file in a predetermined folder, and the display executing unit 202c starts the viewer software specified by the transferred information for the start application and displays images in the image file stored in the predetermined folder on the monitor 214 in the form of display as shown in FIG. 6, using the information for the type and size of the paper as parameters (Step SB3). Specifically, as shown in FIG. 6, the display executing unit 202c maps images in a coordinate system in which the thickness is along X axis, the size is along Y axis, and the paper with or without gloss is along Z axis. As shown in FIG. 7, the display executing unit 202c may map a plurality of images in chronological order in a coordinate system in which the time of acquiring an image is along horizontal axis and the size is along vertical axis. When the image related to the paper whose use is not specified is displayed using the viewer software, then it is possible to check that papers with the same use are collected in a specified area on the coordinate system.

Referring back to FIG. 5, when there is an area on the coordinate system where the images are collected, the setting unit 202d sets new use, storage folder, and start application of the paper for the type and size of the paper corresponding to the area (Step SB4).

The transferring unit 202e transfers the information for the use, the storage folder, and the start application set at Step SB4 to the image reading apparatus 100 (Step SB5).

3. Summary of Present Embodiment, and Other Embodiments

As mentioned above, according to the present embodiment, the type and size of the paper is sensed before reading, the use of the paper is determined based on the sensed type and size of the paper, and the read mode, the start application, and the storage folder are set based on the determined use.

Consequently, the complicated and troublesome setting such as setting of the read mode, selection of an application to be started after the reading, and specification of a storage location of an image is automated, and this allows the usability of the image reading apparatus 100 to be improved. In other words, by previously detecting (discriminating) the paper type, optimal setting of the read mode and various processes (selection of a start application and specification of a storage folder, or the like) performed after the reading can be automated, and thus, the usability of the image reading apparatus 100 can be improved. By concurrently using the information for the type and size of the paper for the sorting of image files, the method for more effective sorting than ever before can be provided.

According to the present embodiment, when the use cannot be specified in use determination, the information for the type and size of the paper is recorded in the image file, and images are mapped using the information for the type and size of the paper as parameters at the time of checking the use by the viewer software. When the images are collected in a specific parameter area, then the new use, start application, and storage folder are set for the parameter area.

This allows display of the image using the type and size of paper as parameters, and thus the information for the new use, start application, and storage folder of the paper can be easily set.

Here, even if the use of the paper cannot be specified, after the paper is repeatedly read again and again, a tendency of the type and size of the paper is exposed to view. For example, the paper for recipe has such a tendency as to be “thick, high reflectance, and B5 size”. Specifically, when images of the paper are displayed using the type and size of the paper as parameters, paper sheets of the same use are integrally mapped. If the images are grouped using, for example, the thickness, the gloss, and the size as parameters, almost all paper sheets for recipe are collected in a specific area.

Therefore, if the tendency of the collection is learned and the images collected in an area are collectively stored in a folder, then the load of operation such as search and sort of images can be largely improved. Specifically, because an image file which has not been sorted is also classified by a fixed rule, the sorting operation is facilitated. Moreover, a new use can be set using the area where the images are collected as parameters. In addition, if there are many images to be mapped in a specific area, the start application can be set for that area.

Moreover, the present invention may be implemented in various different embodiments in the scope of technical idea described in the appended claims other than the embodiment. For example, of the processes explained in the embodiment, all or part of the processes explained as automatically performed ones can be manually performed, or all or part of the processes explained as manually performed ones can be also automatically performed using known methods. A specific configuration of distribution or integration of the apparatuses is not limited to the shown one. The apparatuses can be configured by functionally or physically distributing or integrating all or part of the apparatuses in arbitrary units according to various types of additions or the like or according to functional loads. In addition, the process procedures, the control procedures, the specific names, and the screen examples shown in the present specification and the drawings can be arbitrarily modified unless otherwise specified.

The constituent elements of the image reading apparatus 100 and the information processing apparatus 200 shown in the drawings are functionally conceptual, and need not be physically configured as shown ones. For example, for the process functions respectively provided in the image reading apparatus 100 and the information processing apparatus 200, especially for the process functions respectively performed in the control unit 106 and the control unit 202, all or part thereof may be implemented by a CPU and programs interpreted and executed in the CPU, and may be implemented as hardware by wired logic. The programs are recorded in a recording medium, explained later, and they are mechanically loaded into the image reading apparatus 100 and the information processing apparatus 200 as required. The programs are executed by being loaded into RAM (Random Access Memory), to form the control unit in cooperation with the CPU. In addition, the programs may be stored in an application program server respectively connected to the image reading apparatus 100 and the information processing apparatus 200 via an arbitrary network, and all or part thereof can be downloaded as required. The storage unit 206 (image-file storage unit 206a) is a storage unit for storing therein computer programs to perform various processes, tables, files, and databases or the like. As the storage unit 206, a memory device such as RAM and ROM (Read Only Memory), a fixed disk drive such as a hard disk, a flexible disk, and an optical disc can be used.

The information processing apparatus 200 may be configured as an information processing apparatus (including an information processing apparatus connected with arbitrary peripheral devices) such as known personal computer and work station. The image reading apparatus 100 may be achieved by installing software (including the programs, the data, or the like) to cause the image reading apparatus to implement the setting automation method according to the present invention. The setting automation program according to the present invention may be stored in a computer-readable recording medium or can be configured as a program product. The “recording medium” mentioned here includes a “portable physical medium” that is any of a memory card, a USB (Universal Serial Bus) memory, an SD (Secure Digital) card, a flexible disk, a magneto-optical disc, ROM, EPROM (Erasable Programmable Read Only Memory), EEPROM (Electrically Erasable Programmable Read Only Memory), CD-ROM (Compact Disk Read Only Memory), MO (Magneto-Optical disk), DVD (Digital Versatile Disk), and Blu-ray Disc. The “program” mentioned here is a data processing method described in arbitrary language and description method, and thus any form such as a source code and a binary code is acceptable. It should be noted that the “program” is not necessarily limited to a program configured as a single unit, and, therefore, includes those distributedly configured as a plurality of modules and libraries and those in which the function of the program is achieved in cooperation with separate programs represented as OS. As a specific configuration and a reading procedure to read a recording medium by the apparatuses shown in the embodiments or as an installation procedure after the reading, or the like, known configuration and procedures can be used.

According to the present invention, the control unit sets a mode of image reading performed by the reading unit based on the paper type detected by the paper type sensor. This enables the complicated and troublesome setting such as the setting of the read mode to be automated. Thus, there is such an effect that the usability of the image reading apparatus can be improved.

According to the present invention, the control unit sets an application to be started based on the paper type detected by the paper type sensor. This enables the complicated and troublesome setting, such as the selection of the application to be started after the reading, to be automated. Thus, there is such an effect that the usability of the image reading apparatus can be further improved.

According to the present invention, the control unit sets a folder to store therein an image read by the reading unit based on the paper type detected by the paper type sensor. This enables the complicated and troublesome setting such as the specification of the storage location of the image to be automated. Thus, there is such an effect that the usability of the image reading apparatus can be further improved.

According to the present invention, the control unit records information for the paper type in the image file including the image read by the reading unit, transfers the image file with the information for the paper type recorded therein to the information processing apparatus, and registers at least one information among the application, the folder, and the use of the paper transferred from the information processing apparatus. This enables the image to be displayed using the paper type as a parameter. Thus, there is such an effect that information for new use, start application, and storage folder of the paper can be easily set.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image reading apparatus comprising:
a paper type sensor that detects a paper type of paper;
a control unit; and
a reading unit that performs an image reading, wherein the control unit includes
a mode setting unit that sets a mode of the image reading performed by the reading unit based on the paper type detected by the paper type sensor.

2. The image reading apparatus according to claim 1, wherein the control unit further includes
an application setting unit that sets an application to be started based on the paper type detected by the paper type sensor.

3. The image reading apparatus according to claim 1, wherein the control unit further includes
a folder setting unit that sets a folder for storing therein an image read by the reading unit based on the paper type detected by the paper type sensor.

4. The image reading apparatus according to claim 1, the image reading apparatus being communicably connected with an information processing apparatus, wherein the control unit further includes
a recording unit that records information for the paper type in an image file including an image read by the reading unit,
a transferring unit that transfers the image file with the information for the paper type recorded therein to the information processing apparatus, and
a registering unit that registers at least one information among the application, the folder, and a use of the paper transferred from the information processing apparatus.

5. A setting automation method executed by a control unit of an image reading apparatus that includes a paper type sensor for detecting a paper type of paper, the control unit, and a reading unit for performing an image reading, the setting automation method comprising:
a mode setting step of setting a mode of the image reading performed by the reading unit based on the paper type detected by the paper type sensor.

6. A computer-readable recording medium that stores therein a computer program causing an image reading apparatus to execute a setting automation method, the image reading apparatus including a paper type sensor for detecting a paper type of paper, a control unit, and a reading unit for performing an image reading, wherein the setting automation method executed by the control unit comprising:
a mode setting step of setting a mode of the image reading performed by the reading unit based on the paper type detected by the paper type sensor.
